(19) United States
(12) Patent Application Publication
(10) Pub. No.: US 2003/0115782 A1
(43) Pub. Date: Jun. 26, 2003

(54) Promotional replicas with secondary utilities

(76) Inventor: Jeff Baker, Cicero, IN (US)

Correspondence Address: VAN DYKE & ASSOCIATES, P.A., 7200 LAKE ELLENOR DRIVE, SUITE 252, ORLANDO, FL, 32809, US

(21) Appl. No.: 10/293,899

(22) Filed: Nov. 13, 2002

Related U.S. Application Data
(60) Provisional application No. 60/337,699, filed on Nov. 13, 2001.

(51) Int. Cl. G09F 1/08; B43M 3/00

(52) U.S. Cl. 40/358; 40/538

(57) ABSTRACT

A novelty item for marketing a product, and a method of its use is disclosed. The promotional item comprises as replica of a product being marketed, wherein the item has a secondary utility, such as for example, as a decoration, amusement device or specific utility, that is unrelated to the function of the product being marketed. The item is used as a unique, leave-behind item associated with a sales meeting. In any embodiment, the item encourages client interaction to develop product recognition, increase product loyalty, encourage product referral, and foster goodwill between businesses.

### CROSS-REFERENCE TO RELATED APPLICATIONS

This application is related to U.S. Provisional Application No. 60/337,699, filed Nov. 13, 2001, to which priority is claimed under 35 USC § 119(e).

### FIELD OF THE INVENTION

This invention relates generally to an article designed for promotional or advertising purposes, and specifically to a promotional replica of a product being marketed therewith, where the replica has a secondary utility in addition to the marketing utility, and preferably unrelated to the utility of the product.

### BACKGROUND OF THE INVENTION

Marketing products to a consumer and gaining repeat business has become more difficult as an increasing number of companies sacrifice innovation for financial stability by offering competing products having substantially similar features and specifications. Products designed to match the best product in a class often sell, but these products fail to encourage customer loyalty and repeat business because customers fail to distinguish one product from another. Today, differentiating a product, innovating, and engaging the customer on an emotional level are the keys to a successful marketing plan (Ealey, L. and L. Troyano-Bermudez, The McKinsey Quarterly, 1996 (4):62-75). Traditional “face-to-face, or “one-on-one” selling time with a buyer continues to decline in both quantity and quality. Without some constant reminder, and more particularly a reminder that draws attention to itself, the client may fail to recommend the product, or select it over a similar competing product when re-ordering.

In an effort to increase product awareness, businesses often use promotional items. The art of making and using promotional items is well established. It is a subset of general advertising and marketing in which a physical object, at times a sample of the actual product, rather than paper print advertising, is provided to a customer or a potential customer. These items typically include calendars, pens, magnets, caps, key chains and the like. However, items traditionally used are usually simple products that are only capable of marketing a product in a discreet manner. These gifts often provide little motivation for continued use by a client, thereby minimize their effectiveness as a marketing tool.

It is axiomatic that in the field of advertisement/marketing, perception is often reality. Thus, a novel promotional item may make an immediate, and indelible positive first impression, whereas the presentation of an ordinary, nondescript promotional item may actually foreclose future business opportunities. When a salesperson hands out something unique tied to a particular product, the product makes a biggest impact on the client. The most unique, practical and appealing promotional products will be the ones remembered and the ones most likely to increase customer goodwill, referral & repeat business. A client will likely be interested in receiving an eye-catching promotional item, particularly if it has a secondary function that enables its continued use. The most successful promotional products will be capable of establishing brand recognition by reinforcing a visual message, even when the consumer is not engaged in an activity normally associated with the products use. For example, a client may be inclined to display a unique promotional item having a separate utility on his or her desk for use. Through repeat use of the item, the client will be reminded of the underlying product, thereby increasing the likelihood of repeat business or referrals. The more original the promotional item, the more likely it will be remembered.

Some promotional articles have a secondary function in addition to the primary marketing function. For instance, U.S. Pat. No. 5,975,390 (D. Saroli, Nov. 2; 1999) discloses a removable golf cart cushion that has a space for advertising and that also provides protection from a golf cart side rail, and also provides a holder function for golf accessories.

Some promotional items emulate the actual product being marketed. For instance, U.S. Pat. No. 6,123,361 (M. L. Cohen, Sep. 26, 2000) discloses promotional mailing which includes inserts in an envelope, where the inserts have a promotional message and a simulated reward item. The simulated reward item simulates the actual item being promoted, and is at least partially displayed through a window in the envelope. This is said to provide an incentive to open the envelope. U.S. Pat. No. 6,158,157 (Hiscock and David, Dec. 12, 2000) discloses a promotional item in the shape of a suspended, enlarged replica of a beer bottle cap for use in bars and restaurants. The article houses a magnet which attracts bottle caps. The article has the dual utility of both marketing a product, and providing a place to temporarily store discarded bottle caps. Ideally, the interaction with the product will entice a consumer to purchase the brand name drink advertised on the article.

Some products are marketed in channels in which certain intermediate distributors are key to sales, for example physicians who have the authority to prescribe one pharmaceutical product over another having a similar effect. Here, lest the physician tire of the promotional item and dispose of it, a challenge exists to provide an interesting promotional item that will communicate the message of the product, and also provide secondary utility in the form of decoration, amusement, and/or a specific physical function.

Notwithstanding the aforementioned items, a need remains for promotional items that have both a marketing function and a secondary utility, and that are well suited for intermediate distributors such as physicians.

### SUMMARY OF THE INVENTION

The present invention provides a three-dimensional promotional article that is a replica of the actual product being marketed. Further, the promotional article is designed to provide a secondary function in addition to the primary marketing function. The item is preferably designed to be quickly noticed by everyone within view and provides an excellent advertising medium for any manufacturer or business. In use a marketing program targets a product such as, for example, a capsules of medicine that is developed by a company. A promotional replica of the product which has a secondary utility is manufactured and distributed to clients or employees to promote product awareness. A major advantage of having such secondary utility is that it increases the likelihood that the article will remain in use for a longer period of time and thereby have a longer lasting marketing effect.

In one embodiment the subject invention pertains to a telephone cord spinner that comprises a body and first and second ends. On the first end, the cord spinner comprises a female receiving channel for receiving a standard telephone plug insert. Attached to the second end, the telephone cord spinner comprises an external portion for use as a telephone plug insert. The subject telephone cord spinner is completely functional. i.e. connects a telephone earpiece cord to the telephone and is capable of carrying signals to and from the earpiece of the telephone. The electrical circuitry of the subject cord spinner is preferably in line with other basic, conventional cord spinner such as, for example, U.S. Pat. No. 6,139,332 which is incorporated here by reference. The subject invention also acts to alleviate twisting of the telephone earpiece cord. The body of the telephone cord spinner is designed in a desired novel shape. For example, for targeting pharmaceutical companies and their customers, the body of the cord spinner may take the shape of a tablet, capsule or some other drug form that is manufactured by the company. Preferably, the body can include colors, designs or other indicia associated with a given drug. The body can be altered to represent a product in any line of business. For example, the body of the cord spinner can take other shapes that relate to various interests of the consumer such as, but not limited to a, golf ball, fish, tennis ball, boat, basketball, football, football helmet of a favorite team, soccer ball, guitar, car, bike, home, computer, money, landscape, ship, plane, food or beverage, picture frame, furniture, landmark, animal and others.

In another embodiment a decorative vintage broadcast microphone is designed for placement on a desk or shelf. A portion of the microphone is in the shape of a capsule corresponding to a pharmaceutical agent being marketed in capsule form. The item provides aesthetic value to a setting when displayed and may optionally function as a desk clock if a timepiece is incorporated into its construction. Numerous variations may be made to the structure of this embodiment to convert it for use in another market. For example, to promote a line to golf balls to a consumer, a collection of golf ball may be stacked together and substituted for the capsule design to also give the appearance of a vintage microphone. Upon viewing the unique design, a user will likely be immediately drawn to the item thereby placing the individual in view of a particular marketing design placed on each golf ball. Other materials may also be substituted for the capsule design as desired. By combining a product name with a visually appealing novelty item, the present invention increases the likelihood that when given an option to purchase competing products, the user will select the one associated with the novelty item. In yet another embodiment, a replica of a medicinal capsule is fabricated to hold a roll or stack of notepaper. The replica comprises a recognizable exterior in the shape of a product being marketed and an interior chamber, which contains the notepaper. In a preferred embodiment, the exterior is in the shape of a tablet, capsule, or other design associated with a given drug, and has a button, which when depressed, cause a segment of the replica to open and reveal the interior chamber. The interior chamber comprises a roller having a roll of notepaper placed thereon, or a tray to hold a stack of paper. In use, a user depresses the button on the exterior to access the inside chamber, whereupon a piece of notepaper is obtained for recording a note. This design may be substituted for other designs depending upon the target audience. For example, where the marketing is directed to a football team, a football helmet having a design associated with the team's logo or other desired indicia may be fabricated to hold a roll or stack of note paper in fashion similar to that disclosed for the pharmaceutical above.

Those skilled in the art, in view of the teaching herein, will easily and routinely be able to adapt and configure the outer shell of body of the marketing replica to take a given shape through use of conventional manufacturing techniques. Accordingly, other embodiments not specifically disclosed herein fall within the scope of the invention.

### BRIEF DESCRIPTION OF THE DRAWINGS

FIG. 1A is a perspective view of a first embodiment of the present invention shaped to look like a medicine capsule and having a secondary function as a note holder.

FIG. 1B is a back view of a first embodiment of the present invention shaped to look like a medicine capsule and having a secondary function as a note holder.

FIG. 1C is a side view of a first embodiment of the present invention shaped to look like a medicine capsule and having a secondary function as a note holder.

FIG. 2A is a cross-sectional view of a first embodiment of the present invention shown in a closed position.

FIG. 2B is a cross-sectional view of a first embodiment of the present invention shown in an open position.

FIG. 3 is a side cutout view of a first embodiment of the present invention showing the note holder with paper roll.

FIG. 4A is a front view of a second embodiment of the present invention shaped to look like vintage radio microphone and having a secondary function as a desk clock, wherein the microphone is in the shaped of a medicine capsule.

FIG. 4B is a side view second embodiment of the present invention shaped to look like vintage radio microphone and having a secondary function as a desk clock, wherein the microphone is in the shaped of a medicine capsule.

FIG. 5A is a side view illustrates manner in which the cord spinner embodiment of the present invention is connected between the phone line and a jack provided on a phone handset.

FIG. 5B is a front view of the first end of the cord spinner embodiment showing a plug mounted on a rotatable segment of the cord spinner.

FIG. 5C is a front view of the second end of the cord spinner embodiment showing a jack for receipt of a phone line.

FIG. 5D is an angled side profile of the cord spinner embodiment showing a plug and jack situated between the body of the cord spinner.

FIG. 5E is a side profile of a specialty-marketing container for holding a cord spinner.

FIG. 6A shows a side view of a cutter embodiment of the present invention.

FIG. 6B shows an angled side view of the cutter embodiment engaging a package to be cut open.

FIG. 6C shows a top view of a cutter embodiment showing advertising indicia placed thereon to promote a product.

### DETAILED DESCRIPTION OF THE INVENTION

Advertisement materials are routinely handed out or sold by manufacturers or businesses as a practical type of promotional material. It is apparent that the more striking or obvious the advertising material is, the more it will be noticed by the public and will thus lead to better advertising. Also, as function is provided with the item, the likelihood that a product will be used increases. It has also been learned that making and using promotional items appreciably smaller or larger than the actual item being marketed, also adds to the value of the promotional article. This is believed to be due to the humor value of having, for instance, a replica of a medicinal capsule substantially larger than an actual capsule. The present invention provides a mock-up simulation of a product being marketed which possesses a specific utility unrelated to the product being marketed. The novelty attached to the present invention presents a noteworthy item that catches the attention of the client, or visitors, while simultaneously increasing the marketing potential for the product.

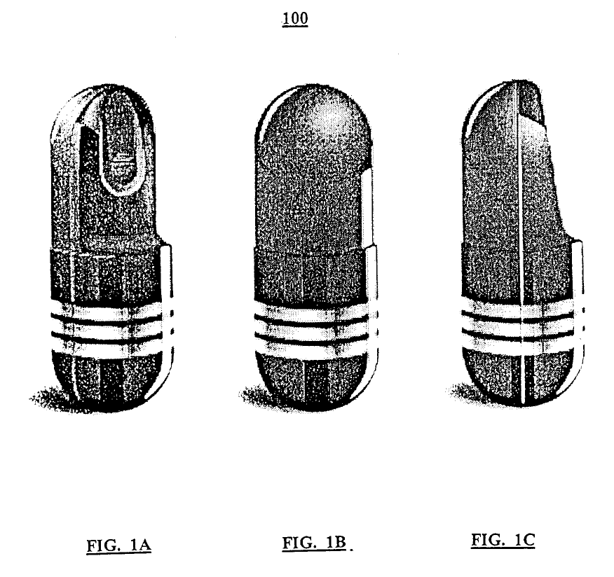

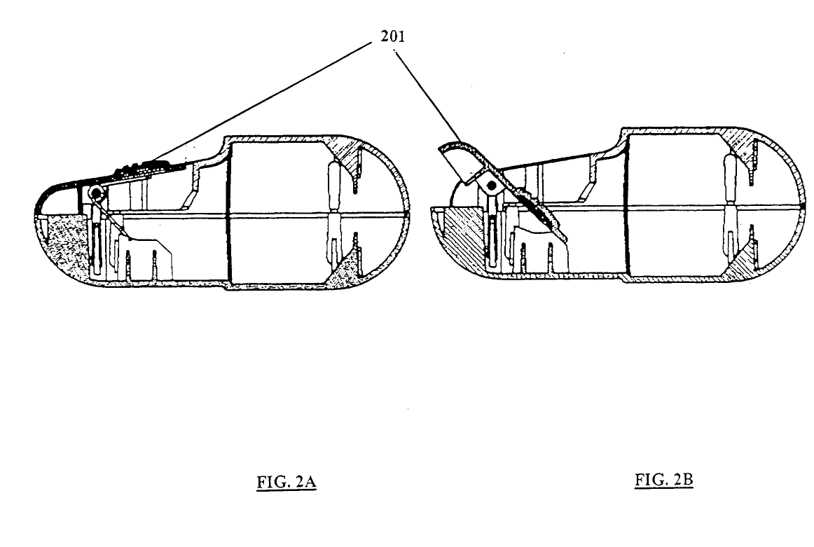

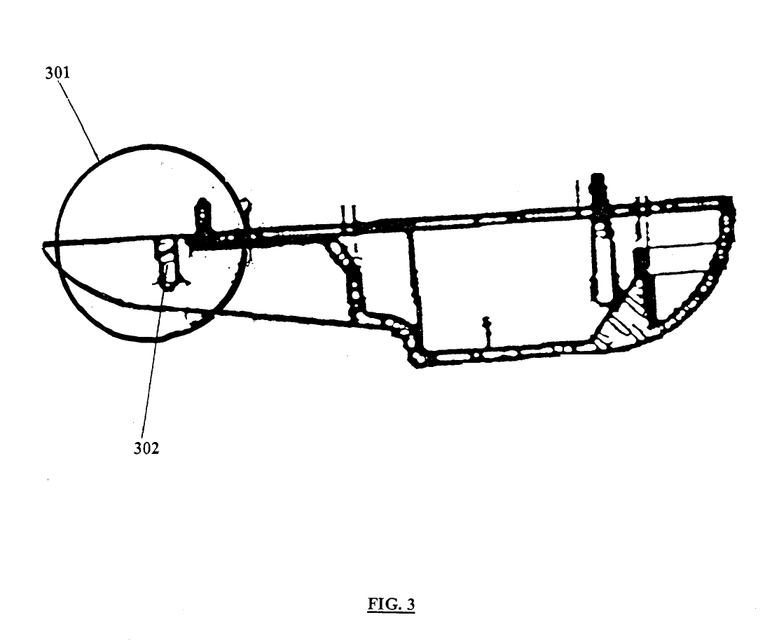

In a preferred embodiment, the promotional item of the present invention is used for marketing a pharmaceutical agent. The item is a replica of a capsule containing medicine and is substantially larger than an actual capsule. The item, generally indicated at 100, has a secondary utility as notepaper holder and is sized for use on a desk, table or the like. FIG. 1A is a perspective view of the item, while FIG. 1B shows a back view and FIG. 1C shows a side view of the item. It should be recognized that the secondary utility of the device is not immediately obvious to a viewer when the item is not being used for that purpose, thereby increasing the aesthetic value of the device as a decorative item. FIGS. 2A and 2B show a side cross-sectional view of the device 100 (see FIG. 1) in a horizontal position as it would rest on a desk, table or the like. FIG. 2A shows a side profile of the device 100 wherein a top push-button release 201 is placed in a closed position. FIG. 2B shows a side profile of the device 100, wherein the push-button release 201 is placed in an open position. FIG. 3 shows a cross sectional cut-away drawing of the bottom portion of the device 100 to show a roll of note paper 301 placed on roller 302 contained within the item. When in a closed position, the item resembles an enlarged medicine capsule without any indication of its intended secondary function. A user may depress the push-button release 201 to reveal a roll of paper 301 contained on a roller 302. A user then pulls a sample of paper from the roll to record a note. This device provides a client with an eye-catching novelty item that may be displayed in an office setting, while providing a useful secondary utility as a note holder. Because the device is both functional and decorative, the likelihood that it will remain in view and in use is increased, thereby extending the marketing effect on the underlying product being promoted.

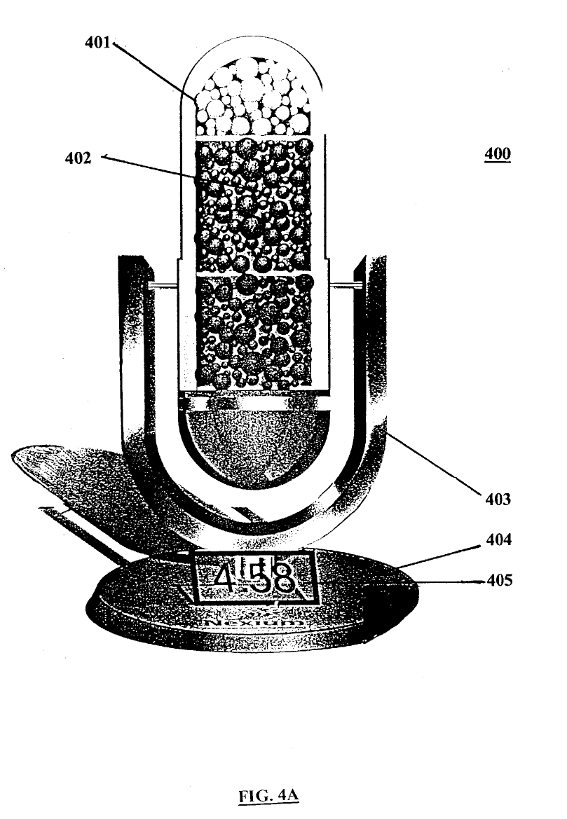

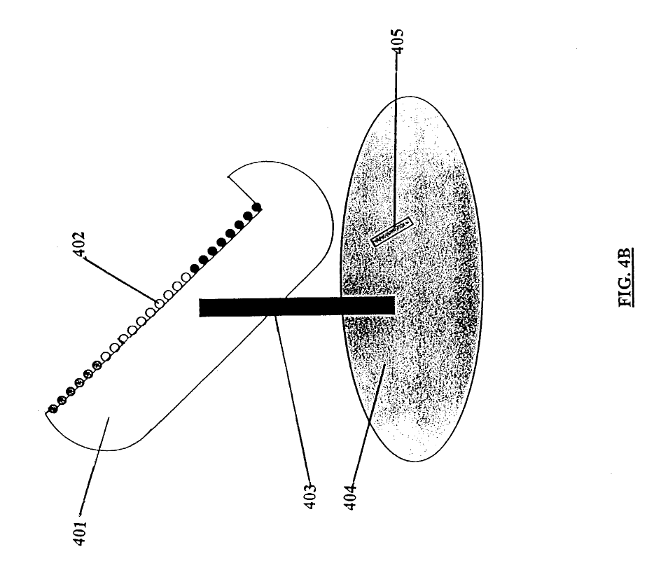

FIG. 4A shows a second embodiment of present invention constructed to resemble a vintage radio broadcast microphone generally indicated at 400. The item has a microphone 401 in the shape of an enlarged medicinal capsule. A portion of the capsule is removed to reveal the medicine 402 contained within the capsule. The microphone capsule 401 is attached to a strut 403, which is supported by a base 404. The item has a primary function as a decorative, marketing/promotional item, and a secondary utility as a clock 405. The novelty associated with this item is that it is a replica of a vintage radio broadcast microphone having a strong aesthetic value. Interest in such microphones is evidenced by the large number of collectors of vintage memorabilia. The unique structure of the device makes it ideal for displaying in an office setting as a decorative furnishing, increasing the likelihood that it will be placed in view for a long period of time. Because the item has a clock placed on it, the device will draw attention to itself on a continual basis and thereby reinforce the product name in the minds of all those who view it.

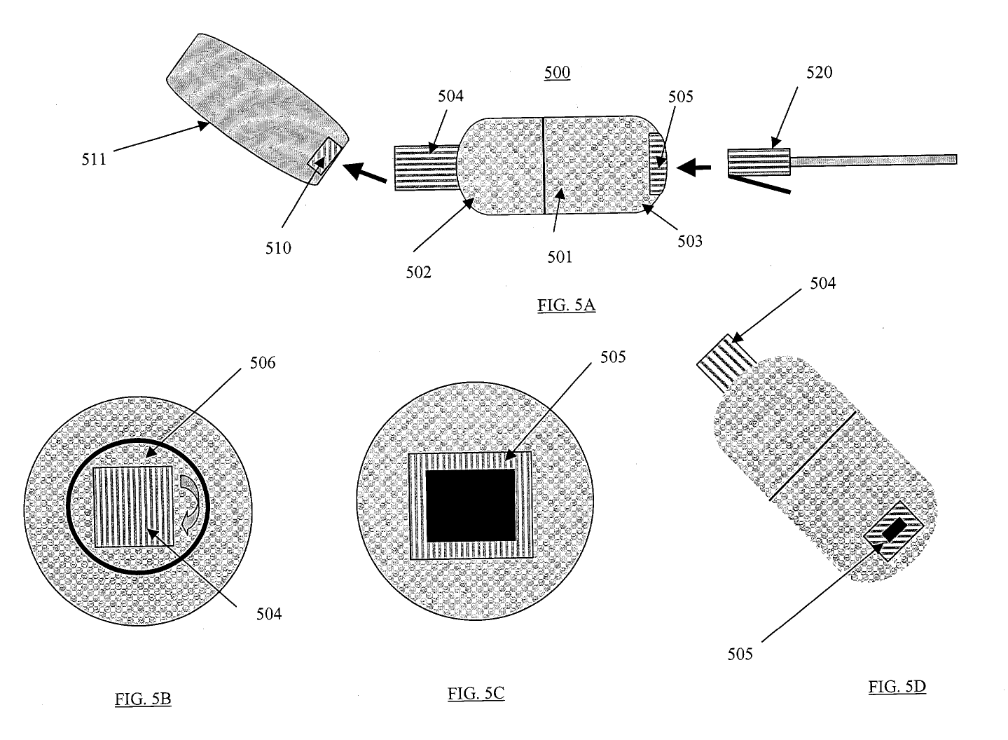

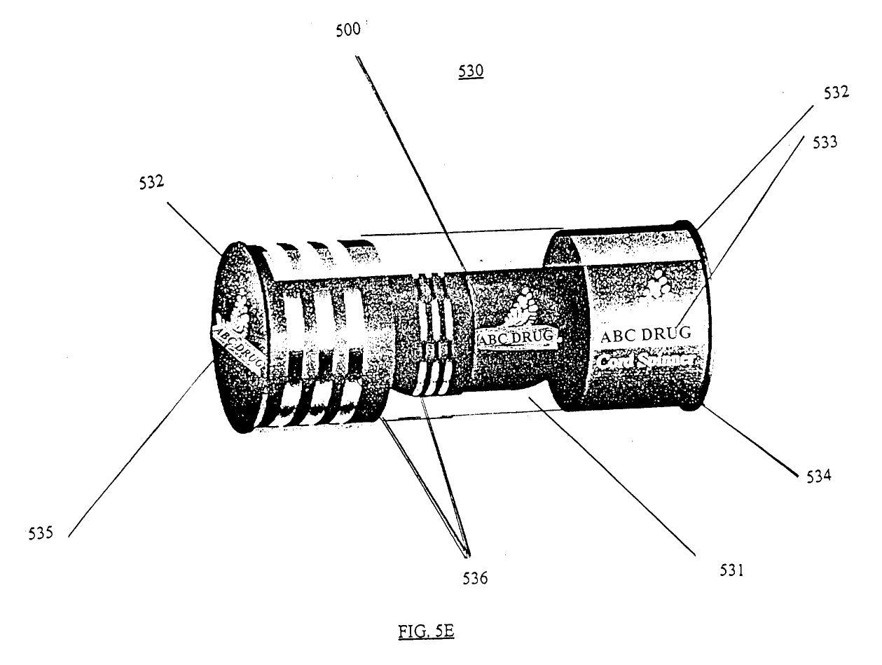

FIG. 5A illustrates the manner in which the cord spinner embodiment of the present invention, generally represented at 500, is connected between a phone line and a phone handset. The cord spinner comprises a body 501 having first 502 and second 503 ends. In a preferred embodiment, the body is designed to resemble, in color and shape, a capsule of a drug manufactured by a client. The first end 502 of the body comprises a male plug 504 for plugging into a jack 510 on a phone handset 511. The second end 503 comprises a jack 505 for receiving a phone cord plug 510. The plug 504 and jack 505 have standard electrical connections similar to those incorporated into other connectors currently available. FIG. 5B shows a front view of the first end of the cord spinner showing the plug 504 extending from a rotatable segment 506 of the body 501. The segment rotates 360° to prevent the cord connected to the second end from tangling. FIG. 5C shows a front view of the second end of the cord spinner showing the jack 505 into which a phone cord plug is received. FIG. 5D is an angled side profile of the cord spinner showing the orientation of the body 501, plug 504 and jack 505. The cord spinner may, alternatively, be connected between a phone cord and a base receiver. FIG. 5E is a side profile of a specialty marketing container for holding a cord spinner embodiment of the present invention. The container adds an additional element to the marketing of a particular product by providing a visually appealing package marked with the product name in several locations to reinforce the name of the product in the mind of a recipient. As shown, a container 530 contains a cord spinner 500, which may be easily viewed through a clear plastic sleeve 531 comprising the body of the container. Over each end of the container, removable plugs 532 are inserted to hold the cord spinner in place. On part of the inserted portion of the plug 532, is emblazoned a large primary logo 533 normally associated with the drug being marketed, and an identification tag 534 describing the secondary function that is performed by the object. A smaller secondary logo 535 is placed on a section of a plug 532 that is not inserted into the container. One or both plugs may have a design 536 that is similar to a design associated with the drug being marketed. Through use of this specialty-marketing container, a recipient will be made immediately aware of both the drug being marketed and the function of the novelty item.

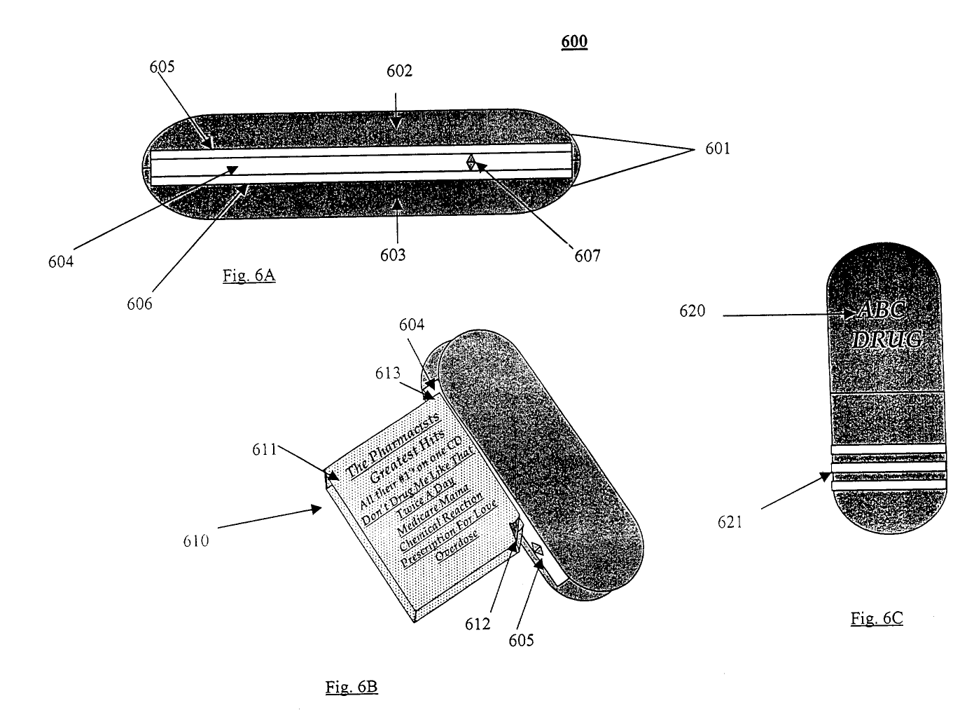

In yet another embodiment, the promotional item of the present is a replica of a capsule containing medicine and is substantially larger than an actual capsule. The item has a secondary utility as a cutter for cutting open packaging film on a box containing a CD, CD-ROM, VCD, DVD disc or the like. FIG. 6A shows a side profile of one embodiment of the cutter, generally represented at 600. The cutter has a body 601 comprising upper 602 and lower 603 halves and a sliding floor 604 formed in the body to receive an edge of a package covered with packaging film. Upper 605 and lower 606 sliding side walls are disposed perpendicular to the floor 604 to keep the edge of the package in contact with the floor as the package is moved toward a blade 607. An arrow shows the direction of movement required to open the box with the cutter. FIG. 6B shows an angled side view of the cutter shaped to resemble a drug capsule, and depicts the process of cutting packaging film on a box. A box 610 covered with packaging film 611 is positioned along one end of the cutter such that it is flush with the floor 604 of the cutter. Through movement in the direction of the arrow, a leading edge 612 of the package contacts the blade 607. The blade 607 cuts to a depth sufficient to remove the packaging film without harming the package. The package is moved forward along its length such that packaging film is cut along the box from the leading edge 612 to a trailing edge 613. FIG. 6C shows a top view of the cutter designed to market a pharmaceutical product. The cutter has advertising indicia placed thereon comprising a product name 620 and a product logo 621, which serve to reinforce product recognition during each use of the cutter. This embodiment expedites the opening of packages rapped in packaging film without damaging the package.

Other embodiments are also contemplated. For example, In another embodiment the item is constructed in the shape of an enlarged medicinal capsule, wherein the device has a secondary utility as a flashlight. One knowledgeable in the field will immediately recognize that a large number of embodiments not disclosed herein, fall within the scope the present disclosure.

In each variation of the disclosed or contemplated items, the name of the product being marketed is overtly located thereon to reinforce name recognition each time the object is viewed. In those cases where the function of the product can be determined by the product name, it may be advantageous to create a novelty item that has no connection with the function of the device. In most cases however, the name of the product will not suggest its use. In those situations where the function of the product is unclear from the name, it may be advantageous to construct a product that indicates its use upon view. In any embodiment, a useful secondary function which encourages continued use is incorporated into the item. This invention is well suited for mass-production and scale-up techniques to reduce marketing costs while ensuring maximum exposure of product.

In view of the foregoing, one can recognize that the present invention provides a unique marketing tool for advertising a product that has a secondary utility capable of aiding a particular activity. It is noted that the figures depicting this invention are merely representative of particular embodiments and are not meant to limit the range of possible configurations. Those skilled in the art will appreciate that the scope of this invention should be measured by the claims appended hereto, and not merely by the specific embodiments exemplified herein.

What is claimed is:

1. A novelty item having a secondary utility as a cord spinner comprising a body and first and second ends, wherein said first end comprises a plug configured for insertion into a jack on a phone handset or telephone set; wherein said second end comprises a jack defined therein to receive a phone cord plug; wherein said body is configured to resemble a product being marketed; and wherein said novelty item is enabled to relay electrical signals between said phone cord and said handset or said telephone set.

2. The novelty item of claim 1, wherein said first end rotates relative to said second end to prevent a telephone cord from tangling, while maintaining the ability to relay said electrical signals

3. The novelty item of claim 2, wherein said plug on said novelty item is rotatable.

4. The novelty item of claim 3, wherein said rotatable plug is enabled to rotate 360°.

5. The novelty item of claim 4, wherein said body is shaped to resemble of a pharmaceutical capsule or tablet.

6. The novelty item of claim 5, wherein said body is configured to resemble a shape selected from the group comprising a golf ball, fish, tennis ball, boat, basketball, football, football helmet, soccer ball, guitar, car, bike, home, computer, money, landscape, ship, plane, food or beverage, picture frame, furniture, landmark, animal and the like.

7. The novelty item of claim 6, wherein said body has indicia placed thereon for the purpose of promoting a product

8. The novelty item of claim 7, wherein said item has a primary utility to market a product.

9. A novelty item having a secondary utility as a note paper holder comprising an exterior shell and an interior chamber, wherein
said exterior shell comprises upper and lower segments releasably connected together to resemble the shape of a product being marketed; and wherein
said interior chamber comprises a roller or tray to accommodate a volume of notepaper.

10. The novelty item of claim 9, wherein said upper segment of said exterior shell is further partitioned to form a movable section having a push-button release segment.

11. The novelty item of claim 10, wherein said body is configured into a shape selected from the group comprising a capsule, tablet, pill, golf ball, fish, tennis ball, boat, basketball, football, football helmet of a favorite team, soccer ball, guitar, car, bike, home, computer, money, landscape, ship, plane, food or beverage, picture frame, furniture, landmark, animal and others.

12. The novelty item of claim 11, wherein said interior chamber further comprises a spring connecting said push button release segment to said lower segment of said exterior shell.

13. The novelty item of claim 12, wherein engagement of said push button release segment depresses said spring which forces open an upper segment of said exterior shell to reveal a portion of said interior chamber containing said roller or tray.

14. The novelty item of claim 13, wherein disengagement of said push button release segment closes said exterior to conceal said roller or tray accommodating said note paper.

15. The novelty item of claim 14, wherein said exterior shell is configured to stand upright on a desk or shelf, said shell tapered to form a narrow top and a wide bottom such that when said item is moved toward a horizontal plane, said item can immediately right itself.

16. The novelty item of claim 9, wherein said exterior shell further comprises a time piece.

17. The novelty item of claim 9, wherein said exterior shell has indicia placed thereon for purposes of promoting a product.

18. The novelty item of claim 9, wherein said item has a primary utility of promoting a product.

19. The novelty item of claim 9, wherein said secondary utility of the device is not immediately obvious to a viewer.

20. A novelty item having a secondary utility as a cutter for cutting packaging film covering a box comprising
a) a body in the shape of a product being marketed;
b) a sliding floor formed in said body for receiving a sliding edge portion of an article to be opened;
c) a sliding side wall surface disposed approximately perpendicularly to said floor for keeping said edge portion in contact therewith and for sliding said edge thereon, and
d) at least one blade disposed on a said floor, said blade disposed parallel to said sliding side wall surface and comprising a lower tip for cutting through said packaging film.

21. The novelty item of claim 20, wherein said item is a cutter for cutting packaging film off a container containing a CD, CD-ROM, DVD disc or the like.

22. The novelty item of claim 21, wherein said item cuts packaging film without damaging said package.

23. The novelty item of claim 22, wherein said item has indicia placed thereon for the purpose of promoting a product

24. A novelty item having a secondary utility as a decorative display, wherein said item is fashioned to resemble a vintage radio broadcast microphone, comprising a body, a support brace and a base, wherein
said body is configured to resemble a product being marketed; wherein
said support brace is connected to said body along the midline of said body; and
wherein said base receives said support brace.

25. The novelty item of claim 24, wherein said body of said item is configured in the shape of a drug capsule.

26. The novelty item of claim 25, wherein a portion of said body in the shape of a drug capsule is designed such that a replica pharmaceutical agent contained therein is visible to a user.

27. The novelty item of claim 26, wherein said item has indicia placed thereon for the purpose of promoting a product

28. The novelty item of claim 27, wherein the said item's primary function is to promote a product.

29. The novelty item of claim 28, wherein said item provides aesthetic value when displayed on a desk or shelf.

30. The novelty item of claim 29, further comprising a timepiece connected to said base.

31. A novelty item for marketing a product, wherein the item has a secondary utility.

32. The novelty item of claim 31, wherein said secondary utility is unrelated to the product being marketed.

33. The novelty item of claim 32, wherein said secondary utility comprises a decorative function, amusement function, physical function or combinations thereof.

34. The novelty item of claim 33, wherein the item is a replica of the product being marketed.

35. The novelty item of claim 34, wherein said replica is larger or smaller than the product being marketed.

36. The novelty item of claim 35, wherein said replica has indicia thereon for purposes of promoting the product.

37. The novelty item of claim 36, wherein said item is disbursed to intermediate product distributors.

38. The novelty item of claim 37, wherein said intermediate product distributor is a Physician.

39. The novelty item of claim 38, wherein said intermediate product distributor is a Psychiatrist.

40. The novelty item of claim 39, wherein said item has a positive effect on said marketing program, said effect comprising increased repeat business, increased product referral, increased goodwill and combinations thereof.

41. A method of marketing a product comprising:
a) producing a promotional item having a primary utility and secondary utility;
wherein said item has indicia placed thereon for purposes of promoting said product; and
b) distributing said promotional item to prospective or existing clients for display, interaction and/or use.

42. The method of claim 41, wherein said promotional item is a replica of the product being marketed.

43. The method of claim 42, wherein said replica is larger or smaller than said product being marketed.

44. The method of claim 43, wherein said secondary utility is unrelated to said primary utility.

45. The method of claim 44, wherein said primary utility of said item is to market a product.

46. The method of claim 45, wherein said secondary utility comprises a decorative function, amusement function, physical functional and combinations thereof.

47. The method of claim 46, wherein said existing or prospective client is an intermediate product distributor.

48. The method of claim 47, wherein said intermediate product distributor is a Physician.

49. The method of claim 48, wherein said intermediate product distributor is a Psychiatrist.

50. An improved method of marketing a product using a promotional item, wherein the improvement consists of a promotional item developed to increase repeat business, encourage product referral and develop goodwill, said item constructed to form a scaled up or scaled down replica of the product being marketed, wherein said item has a primary marketing function and a secondary utility unrelated to the function of the product being marketed.
